(19) United States
(12) Patent Application Publication
(10) Pub. No.: US 2026/0268622 A1
(43) Pub. Date: Sep. 10, 2026

(54) SYSTEM, METHOD, AND USER INTERFACE FOR RENDERING THREE-DIMENSIONAL ENVIRONMENTS

(71) Applicant: Cosmosx Ltd., London (GB)

(72) Inventors: Annie Siara PETTEMERIDES, London (GB); Praveen Kumar THAKUR, London (GB)

(21) Appl. No.: 19/555,614

(22) Filed: Mar. 3, 2026

Related U.S. Application Data
(60) Provisional application No. 63/766,752, filed on Mar. 4, 2025.

(51) Int. Cl. G06T 19/20; G06Q 30/0601; G06T 19/00

(52) U.S. Cl. CPC G06T 19/20; G06T 19/003; G06Q 30/0643; G06T 2200/24; G06T 2210/32; G06T 2219/024; G06T 2219/2012; G06T 2219/2016

(57) ABSTRACT

A method of configuring and deploying a 3D environment includes receiving, via a user interface, a selection of a 3D environment template; receiving one or more first inputs for configuring one or more attributes of the 3D environment template; receiving one or more second inputs comprising access parameters of an information source, the information source having information on one or more objects; retrieving the information on the one or more objects from the information source; receiving, one or more third inputs comprising a selection of one or more objects; rendering the 3D environment template responsive to the first and third inputs; and, deploying a 3D environment based on the 3D environment template, the 3D environment being accessible by an end user and the 3D environment being configured to cause, in response to detecting end user interaction with the one or more objects, display of the retrieved information.

### FIELD

This application claims the benefit of U.S. Provisional Patent Application No. 63/766,752; filed: Mar. 4, 2025, and titled “SYSTEM, METHOD, AND USER INTERFACE FOR RENDERING THREE-DIMENSIONAL ENVIRONMENTS,” which is incorporated herein by reference in its entirety.

This disclosure relates generally to virtual 3D environments, and more specifically to software applications for rendering 3D environments.

### BACKGROUND

Configuring and implementing new virtual 3D environments typically requires significant manual preparation and use-case-specific data processing, including modelling the 3D space, applying textures, configuring lighting and physics, and ensuring that the components of the environment interact properly with one another. These processes typically involve multiple stages of development, testing, and optimization to meet specific design requirements. Therefore, a high degree of technical expertise and sophisticated rendering engines are usually needed to create new 3D environments. Furthermore, significant amounts of data must be pre-loaded by a rendering engine to ensure smooth rendering, which slows down the rendering process if the data is not optimized or if the engine needs to integrate with external data sources that have variable latency. This is particularly problematic if the 3D environment includes dynamic elements, like models that need to be loaded and rendered on-the-fly. Accordingly, the time needed to render and display a 3D environment may exceed 10-12 hours in some cases.

### SUMMARY

Existing 3D rendering systems can encounter problems with handling the rapid, on-the-fly data processing required for real-time rendering, resulting in slower rendering times. Further, rendering engines that are typically used to create new 3D environments often lack functionalities that are accessible to, and usable by, individuals who may not have specialized knowledge or experience in areas of 3D design.

Provided herein are systems, methods, and user interfaces for rendering 3D environments. The systems, methods, and user interfaces of the present disclosure may improve upon the deficiencies of existing rendering systems in various ways. In some examples, the systems and methods provided herein allow for 3D environments to be rendered on-the-fly responsive to user inputs, as opposed to conventional rendering engines where rendering a 3D environment can take hours. The increased rendering speed can be attributed to the manner in which user inputs for configuring attributes of the 3D environment are processed and stored by the system.

For example, a system provided herein includes a 3D environment rendering platform, which may be configured to interface directly with a cloud storage solution where editable attributes of a 3D environment template (e.g., colors, textures, objects, images/videos, audio, etc.) are stored and updated in real time as inputs are received from the user. Existing gaming engines often accept customizations to a 3D environment and then implement these customizations all at once at the end of the design process, which ultimately slows down the rendering of the updated 3D environment and does not allow for a user to visualize their changes as they are made. In contrast, in one or more embodiments of the present disclosure, a user may provide an input corresponding to an attribute to be changed in the 3D environment, and a stored value corresponding to the attribute of the 3D environment can be updated in real time in the storage solution. The real time updating of the attribute of the 3D environment, in tum, allows for the 3D environment rendering platform to visually reflect the change in the attribute in real time. Furthermore, this may increase the speed of rendering new 3D environments compared to existing technologies by reducing the number of queries that the rendering platform needs to make to a storage solution of the system during the rendering process.

A system provided herein may also include an integration module for integrating with the application programming interface (API) of an information source, enabling the automatic retrieval of information corresponding to an object (e.g., an object to be virtually represented in the virtual 3D environment, such as product in a virtual store) that a user may wish to add as an interactive element to a 3D environment template. The retrieved information may be automatically displayed to an end user of the published 3D environment as the user interacts with the corresponding object, enabling an informative and immersive end user experience.

Furthermore, a user interface is provided that may streamline the process of designing a 3D environment for users who may lack design or technical experience or expertise. The designing user (referred to herein as the “user” who designs the 3D environment, as distinguished from the “end user” who uses and interacts with the deployed 3D environment) may be provided with base environment templates that may be edited directly using the user interface. The user interface may guide and/or prompt the user through various stages of the design process, and the rendered 3D environment template may be updated by the rendering platform in real time, based on inputs to the graphical user interface from the user, so that the user may visualize their design progression. Once the design process is complete, a user may receive a shareable link for inviting others as end users to their immersive 3D experience.

By streamlining the 3D environment design process through the systems, methods, and user interfaces provided herein, opportunities to launch immersive environments in web browsers and/or virtual reality (VR)/augmented reality (AR) platforms may be made more accessible to individuals.

In some examples, a method of configuring and deploying a three-dimensional (3D) environment is provided, which includes: receiving, via a user interface, a selection of a 3D environment template for customization; displaying the selected 3D environment template in the user interface; receiving, via the user interface, one or more first inputs for configuring one or more attributes of the 3D environment template; rendering the displayed 3D environment template to reflect the one or more first inputs; receiving, via the user interface, one or more second inputs comprising one or more access parameters of an information source, the information source comprising information on one or more objects; retrieving, based on the one or more second inputs, the information on the one or more objects from the information source; receiving, via the user interface, one or more third inputs comprising a selection of one or more objects to be rendered in the 3D environment template; rendering the 3D environment template to reflect the selection of the one or more objects in the one or more third inputs; receiving, via the user interface, an instruction for deploying the 3D environment template; and in response, deploying a 3D environment based on the 3D environment template and the retrieved information associated with the one or more objects, wherein the 3D environment is accessible at a network location to one or more end users, and wherein the 3D environment is configured as an interactive 3D environment that causes, in response to detecting end user interaction with the one or more objects in the 3D environment, display of the retrieved information associated with the one or more objects.

In some examples, the 3D environment template includes an interactive preview of the 3D environment configured to be navigated using the user interface.

In some examples, the method includes storing data representing one or more attributes of the 3D environment template in a cloud storage location; and in response to receiving, via the user interface, the one or more first inputs for configuring the one or more attributes of the 3D environment template, updating the data representing the one or more attributes stored in the cloud storage location.

In some examples, the one or more first inputs for configuring the one or more attributes of the 3D environment template include an image to be displayed in the 3D environment template.

In some examples, the one or more first inputs for configuring the one or more attributes of the 3D environment template include video to be displayed in the 3D environment template.

In some examples, the one or more first inputs for configuring the one or more attributes of the 3D environment template include a selection of a gamification element to be displayed in the 3D environment template.

In some examples, the method includes, in response to receiving the instruction for deploying the 3D environment, generating a shareable link to the deployed 3D environment.

In some examples, the method includes, in response to receiving the instruction for deploying the 3D environment, exporting a file comprising the 3D environment template; and storing the file including the 3D environment template.

In some examples, the one or more third inputs include a selection of one or more locations in the 3D environment template where the one or more objects are to be placed.

In some examples, the one or more access parameters include a URL, a URL endpoint, an API key, an API password, an access token, an admin token, a consumer key, a consumer secret, an API login endpoint, a product inventory API endpoint, admin API credentials, or any combination thereof.

In some examples, a system is provided, including one or more processors; and memory storing computer program code executable by the one or more processors to cause the system to: receive, via a user interface, a selection of a 3D environment template for customization; display the selected 3D environment template in the user interface; receive, via the user interface, one or more first inputs for configuring one or more attributes of the 3D environment template; render the displayed 3D environment template to reflect the one or more first inputs; receive, via the user interface, one or more second inputs comprising one or more access parameters of an information source, the information source comprising information on one or more objects; retrieve, based on the one or more second inputs, the information on the one or more objects from the information source; receive, via the user interface, one or more third inputs comprising a selection of one or more objects to be rendered in the 3D environment template; render the 3D environment template to reflect the selection of the one or more objects in the one or more third inputs; receive, via the user interface, an instruction for deploying the 3D environment template; and in response, deploy a 3D environment based on the 3D environment template and the retrieved information associated with the one or more objects, wherein the 3D environment is accessible at a network location to one or more end users, and wherein the 3D environment is configured as an interactive 3D environment that causes, in response to detecting end user interaction with the one or more objects in the 3D environment, display of the retrieved information associated with the one or more objects.

In some examples, the 3D environment template includes an interactive preview of the 3D environment configured to be navigated using the user interface.

In some examples, the system is further caused to store data representing one or more attributes of the 3D environment template in a cloud storage location; and in response to receiving, via the user interface, the one or more first inputs for configuring the one or more attributes of the 3D environment template, update the data representing the one or more attributes stored in the cloud storage location.

In some examples, the one or more first inputs for configuring the one or more attributes of the 3D environment template include an image to be displayed in the 3D environment template.

In some examples, the one or more first inputs for configuring the one or more attributes of the 3D environment template comprise video to be displayed in the 3D environment template.

In some examples, the one or more first inputs for configuring the one or more attributes of the 3D environment template include a selection of a gamification element to be displayed in the 3D environment template.

In some examples, the system is further caused to in response to receiving the instruction for deploying the 3D environment, generate a shareable link to the deployed 3D environment.

In some examples, the system is further caused to in response to receiving the instruction for deploying the 3D environment, export a file including the 3D environment template; and store the file comprising the 3D environment template.

In some examples, the one or more third inputs include a selection of one or more locations in the 3D environment template where the one or more objects are to be placed.

In some examples, the one or more access parameters include a URL, a URL endpoint, an API key, an API password, an access token, an admin token, a consumer key, a consumer secret, an API login endpoint, a product inventory API endpoint, admin API credentials, or any combination thereof.

In some examples, a non-transitory computer readable storage medium storing one or more programs, the one or more programs including instructions, which, when executed by a system including one or more processors and memory, cause the system to: receive, via a user interface, a selection of a 3D environment template for customization; display the selected 3D environment template in the user interface; receive, via the user interface, one or more first inputs for configuring one or more attributes of the 3D environment template; render the displayed 3D environment template to reflect the one or more first inputs; receive, via the user interface, one or more second inputs comprising one or more access parameters of an information source, the information source including information on one or more objects; retrieve, based on the one or more second inputs, the information on the one or more objects from the information source; receive, via the user interface, one or more third inputs comprising a selection of one or more objects to be rendered in the 3D environment template; render the 3D environment template to reflect the selection of the one or more objects in the one or more third inputs; receive, via the user interface, an instruction for deploying the 3D environment template; and in response, deploy a 3D environment based on the 3D environment template and the retrieved information associated with the one or more objects, wherein the 3D environment is accessible at a network location to one or more end users, and wherein the 3D environment is configured as an interactive 3D environment that causes, in response to detecting end user interaction with the one or more objects in the 3D environment, display of the retrieved information associated with the one or more objects.

In some examples, any one or more of the characteristics of any one or more of the systems, methods, and/or computer-readable storage mediums recited above may be combined, in whole or in part, with one another and/or with any other features or characteristics described elsewhere herein.

As used herein, reference to the act of “rendering” encompasses the act of visually applying and/or changing one or more attributes (e.g., geometry, color, texture, position, orientation) of a digital 3D model of an object and/or an environment. Reference to a “rendered”3D object and/or environment encompasses the visual representation of the 3D object and/or environment once the one or more attributes have been applied or changed.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates a system for configuring and deploying 3D environments, according to one or more aspects of the present disclosure.

FIG. 2A illustrates a method for configuring and deploying 3D environments, according to one or more aspects of the present disclosure. FIG. 2B is a continuation of FIG. 2A.

FIG. 3 and FIG. 4 illustrate a preview of a 3D environment template, according to one or more aspects of the present disclosure.

FIGS. 5-7 illustrate a user interface for customizing a selected 3D environment template, according to one or more aspects of the present disclosure.

FIG. 8 illustrates an information source input page of a user interface, according to one or more aspects of the present disclosure.

FIG. 9 illustrates an object information input page of a user interface, according to one or more aspects of the present disclosure.

FIG. 10 and FIG. 11 illustrate a menu displayed in a user interface for adding 3D objects to a 3D environment template, according to one or more aspects of the present disclosure.

FIG. 12 illustrates a gamification page of a user interface, according to one or more aspects of the present disclosure.

FIG. 13 illustrates a deployment page of a user interface, according to one or more aspects of the present disclosure.

FIGS. 14-16 illustrate an end user experience in a 3D environment, according to one or more aspects of the present disclosure.

FIG. 17 illustrates a computer, according to one or more aspects of the present disclosure.

FIG. 18 illustrates a menu displayed in a user interface for adding 3D objects to a 3D environment template, according to one or more aspects of the present disclosure.

FIG. 19 illustrates a user profile configuration page, according to one or more aspects of the present disclosure.

FIG. 20 illustrates an end user experience personalization page, according to one or more aspects of the present disclosure.

FIG. 21 illustrates a gamification customization page, according to one or more aspects of the present disclosure.

### DETAILED DESCRIPTION

Described are systems, methods, and user interfaces for rendering and displaying 3D environments. In some examples, a method of displaying a 3D environment may include receiving, via a user interface of a software application, a user selection of a 3D environment template. One or more attributes of the 3D environment template, including lighting, colors and textures of structural features, images, audios, and videos, may be edited and/or customized through user inputs that are received in a user interface.

In some examples, a 3D environment rendering platform may be an application that is hosted on a cloud-based backend service. Information on the user's edits to the 3D environment template may be stored in a cloud native storage solution that may be hosted on the cloud-based backend service. In some examples, the 3D environment rendering platform may be configured to access the cloud native storage solution directly, such that, in response to receiving and storing user inputs in the cloud native storage solution, the rendered 3D environment template may be updated in real- or near-real time by the 3D environment rendering platform.

A user may be able to add objects to the 3D environment template that can be viewed and/or interacted with by end users of the published 3D environment. A user may input a location of an information source (e.g., a web page or a software application) into the user interface that includes information on the objects they wish to add. An integration module on the backend of the application may be configured to retrieve information from the information source and display the retrieved information to the user of the user interface. The user may edit the retrieved information via the user interface and may select one or more objects to be added to the 3D environment template. The 3D environment rendering platform may render the updated 3D environment template to include the selected objects as the user selections are received at the user interface. The user interface may be configured such that, in response to an end user interacting with the object once the 3D environment has been published, the retrieved information is displayed to the user.

Once the user has finished customizing the 3D environment template, the user may select an option in the user interface for previewing the end user experience and/or for deploying the template as an interactive 3D environment that may be accessed by end users. In some examples, a shareable link may be displayed in the user interface upon publication, such that the user may invite others to attend their 3D experience. Accordingly, through the systems, methods, and user interfaces provided, a user may create personalized, interactive 3D environments in a highly customizable and easily accessible manner.

In the following description of the various embodiments, it is to be understood that the singular forms “a,” “an,” and the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

### Exemplary Systems and Methods for Rendering Three-dimensional Environments

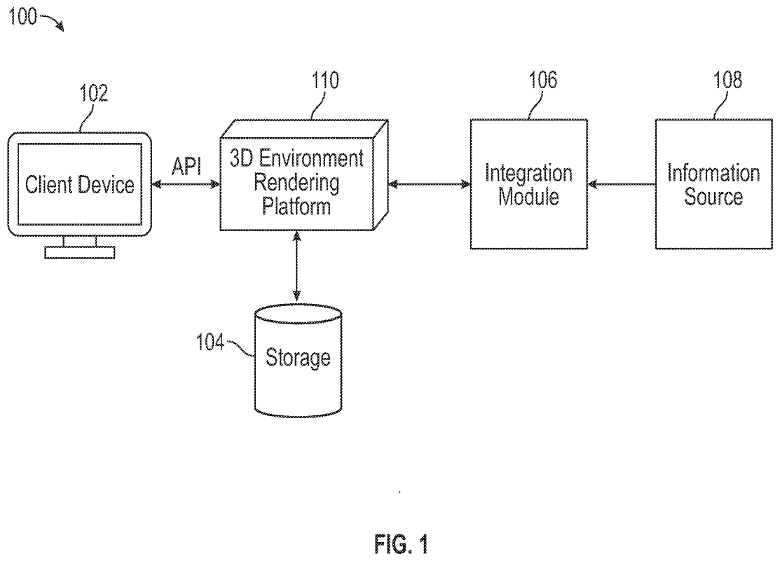

FIG. 1 illustrates a system 100 for rendering 3D environments, according to some examples. System 100 can include a client device 102 for hosting the frontend of a software application, 3D environment rendering platform 110, for rendering 3D environments. The frontend may include a user interface, as will be described in further detail. Client device 102 may include one or more processors and may be connected to a display and one or more devices for receiving inputs from a user and/or for displaying outputs. Client device 102 may be, for example, a desktop or laptop computer, a pair of VR goggles, or a mobile device such as a smartphone or a tablet that is connected to a network. Client device 102 may optionally have a touchscreen for facilitating touch-based interactions with the user interface.

System 100 may also include a 3D environment rendering platform 110. 3D environment rendering platform 110 may include a frontend application (e.g., a user interface) and a backend infrastructure. 3D environment rendering platform 110 may generate and manage data requests and queries from the frontend application to one or more components of the backend infrastructure. 3D environment rendering platform 110 may also transmit information to and from different components of the backend infrastructure, for example, between integration module 106 and/or storage 104. In some examples, the backend infrastructure of 3D environment rendering platform 110 may be implemented on a cloud computing service such as Amazon Elastic Compute Cloud (EC2), Azure Virtual Machines, Alibaba Cloud, or Google Compute Engine. 3D environment rendering platform 110 may launch one or more instances, or virtual servers, that may allocate computing resources from a host computer to various components of the backend infrastructure of system 100 to meet resource and performance demands for real-time 3D rendering. 3D environment rendering platform 110 may communicate with different components of system 100 through one or more application programming interface (API) calls, which can ensure that requests and/or responses between the frontend and the backend are correctly understood and processed. 3D environment rendering platform 110 may also include one or more software modules configured to perform the rendering functionalities of the system. For example, software modules of 3D environment rendering platform 110 may be configured to create and load templates of 3D environments, apply attributes such as textures, lighting, and audio based on user inputs, simulate physics, generate user-interactive components, and perform data processing tasks on large amounts of data in a rapid manner. 3D environment rendering platform 110 may be configured to perform these and other functionalities using code programmed in any suitable programming language, including but not limited to C, C#, C++, Python, Rust, Lua, React JS, Node JS, and/or JavaScript. In some examples, 3D environment rendering platform 110 may be configured to access and fetch data directly from a cloud native storage solution during the rendering process. By integrating a cloud native storage solution into the rendering process, this may help to consolidate and/or reduce the number of queries made to a database, which may advantageously reduce latency during the rendering process.

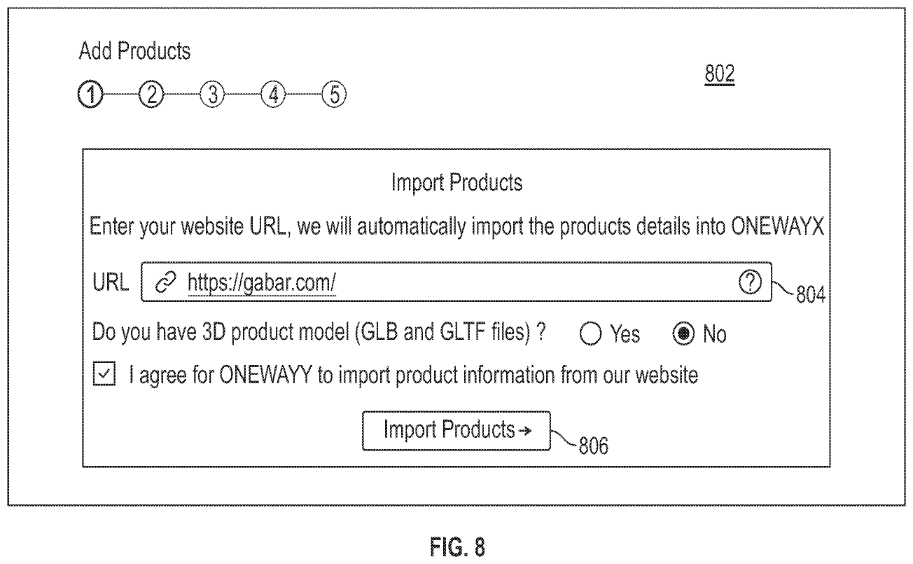

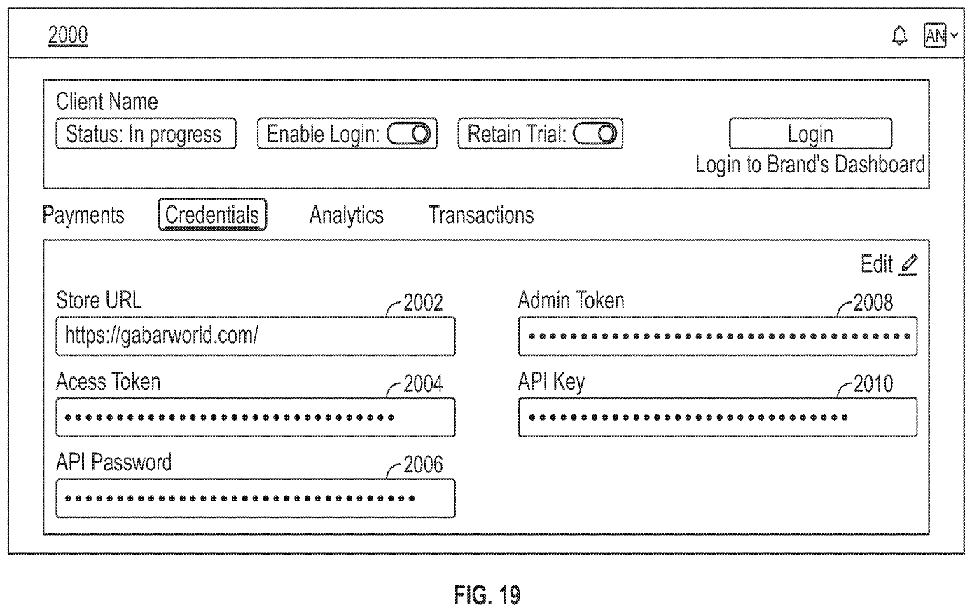

Additionally, system 100 may include an integration module 106. Integration module 106 may be configured to retrieve data from an information source 108, which may be a website, a document, or a software application. Information source 108 may include information that is to be retrieved and made available to an end user of the 3D environment. A frontend or a backend user of 3D environment rendering platform 110 may be able to provide an input including one or more access parameters of an information source 108. For example, FIG. 8 illustrates an information source input page 802 of a user interface where a frontend user may input a URL that the integration module may use to retrieve front-facing information from a website. FIG. 19 illustrates an example of a user profile configuration page 2000 where a backend user may provide access parameters that can be used to provide integration module 106 with access to an API of an information source associated with the frontend user for retrieval of information from the backend of the information source 108. In some examples, the access parameters may include one or more of a URL 2002, a URL endpoint, an API key 2010, an API password 2006, an access token 2004, an admin token 2008, a consumer key, a consumer secret, an API login endpoint, a product inventory API endpoint, and admin API credentials.

The access parameters used to access the information source 108 may vary between different types of information sources. For example, integration module 106 may be configured to be compatible with the APIs of various types of information sources 108. The access parameters for the information source may optionally be stored in storage 104 so that a user does not need to input the access parameters more than once. The input including the access parameters may be received by 3D environment rendering platform 110 and routed to integration module 106. Using the received access parameters, the integration module 106 may be configured to retrieve frontend data from information source 108 (e.g., from a front-facing webpage) and may also retrieve backend data from an information source 108 by accessing and integrating with the API of information source 108. Accordingly, integration module 106 may be configured to be compatible with the APIs of various types of information sources 108 (for example, the APIs of e-commerce platforms such as Shopify, Magenta, SalesForce, Oracle Commerce, Wix, Squarespace, and/or WordPress).

System 100 may also include storage 104, which may include a cloud native storage solution hosted on the cloud computing service. Storage 104 may include a relational database such as MariaDB, MySQL, or PostgreSQL. Storage 104 may be used to store baseline configurations of 3D environments (e.g., environment templates including default colors and textures, locations designated for uploaded media to be displayed within the 3D environment, and so on), and of user customizations during environment customization process. For example, a user may provide one or more inputs changing different attributes of a 3D environment compared to the default configuration provided in a preexisting template of the 3D environment. As a user changes an attribute of the 3D environment, for example, changing the lighting within the 3D environment, the 3D environment rendering platform 110 may be configured to update the corresponding attribute in storage 104 in real time. Therefore, the attributes stored in storage 104 may change with each user input. In turn, the 3D environment rendering platform may update the rendered 3D environment in real time so that the user may visualize their changes. Accordingly, by designating certain attributes of the 3D environment template as being customizable, and by updating these attributes in storage 104 as user inputs are received, rendering speeds and the overall user experience can be improved.

Storage 104 may additionally be used to store information from information source 108 that is retrieved by integration module 106. By directly accessing and integrating with the API of information source 108, changes made to the information in the information source 108 may be automatically reflected in the data that is stored in storage 104. For example, updates to product inventories such as sizes or colors in stock and updates to pricing information may be automatically stored by virtue of direct integration between the integration module 106 and the API of information source 108. Storage 104 may also be used to store the GLB or GLTF file, as well as location information for the 3D environment (e.g., a URL) once the 3D environment has been finalized and published by the user.

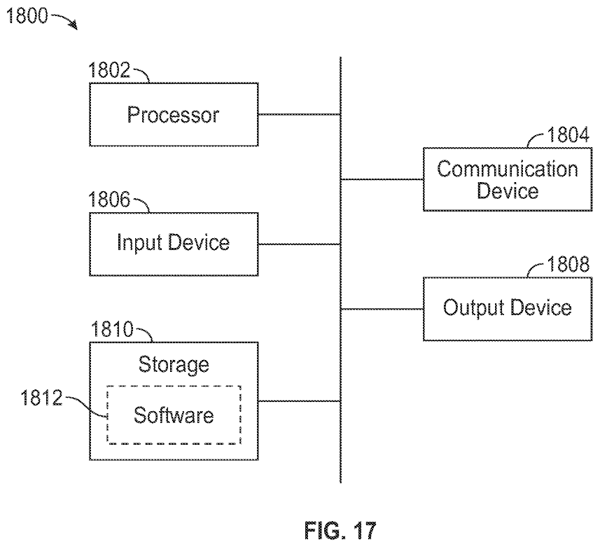

FIG. 17 depicts a computer 1800, in accordance with various embodiments. One or more components of computer 1800 may make up one or more components of system 100 as described herein. For example, computer 1800 can be a host computer connected to a network (e.g., a computer hosting 3D environment rendering platform 110). Computer 1800 can be a client computer or a server (e.g., client device 102). As shown in FIG. 17, computer 1800 can be any suitable type of microprocessor-based device, such as a personal computer, workstation, server, videogame console, or handheld computing device, such as a phone or tablet. The computer can include, for example, one or more of processor 1801, computer input device 1802, output device 1803, storage 1804, and communication device 1805. Computer input device 1802 can generally correspond to those described above and can either be connectable or integrated with the computer.

Computer input device 1802 can be any suitable device that provides input, such as a touch screen or monitor, keyboard, mouse, or voice-recognition device. Output device 1803 can be any suitable device that provides output, such as a touch screen, monitor, printer, disk drive, or speaker.

Storage 1804 can be any suitable device that provides storage, such as an electrical, magnetic, or optical memory, including a RAM, cache, hard drive, CD-ROM drive, tape drive, removable storage disk, or other non-transitory computer readable medium. Storage 1804 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 1805 can include any suitable device capable of transmitting and receiving signals over a network, such as a network interface chip or card. The components of the computer can be connected in any suitable manner, such as via a physical bus or wirelessly. Storage 1804 can be a non-transitory computer-readable storage medium comprising one or more programs, which, when executed by one or more processors, such as processor 1801, cause the one or more processors to execute methods described herein.

Software 1806, which can be stored in storage 1804 and executed by processor 1801, can include, for example, the programming that embodies the functionality of the present disclosure (e.g., as embodied in the systems, computers, servers, and/or devices as described above). In some embodiments, software 1806 can be implemented and executed on a combination of servers such as application servers and database servers.

Software 1806, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 1804, that can contain or store programming for use by or in connection with an instruction execution system, apparatus, or device.

Software 1806 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 1800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1800 can implement any operating system suitable for operating the network. Software 1805 can be written in any suitable programming language, including, but not limited to C, C#, C++, Python, Rust, Lua, React JS, Node JS, and/or JavaScript. In various embodiments, application software embodying the functionality of the present disclosure can be deployed in different configurations, such as in a client/server arrangement or through a web browser as a Web-based application or Web service, for example.

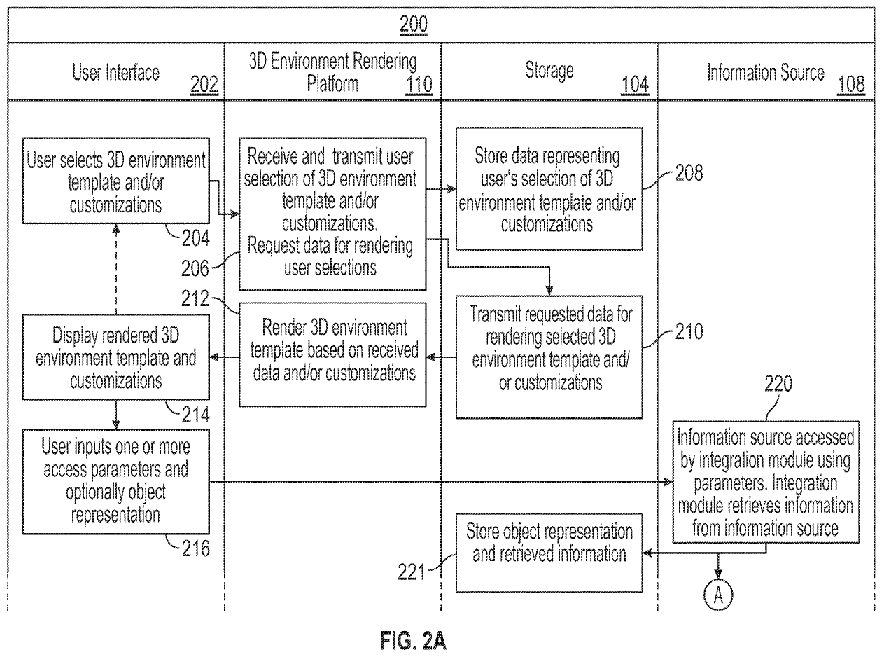

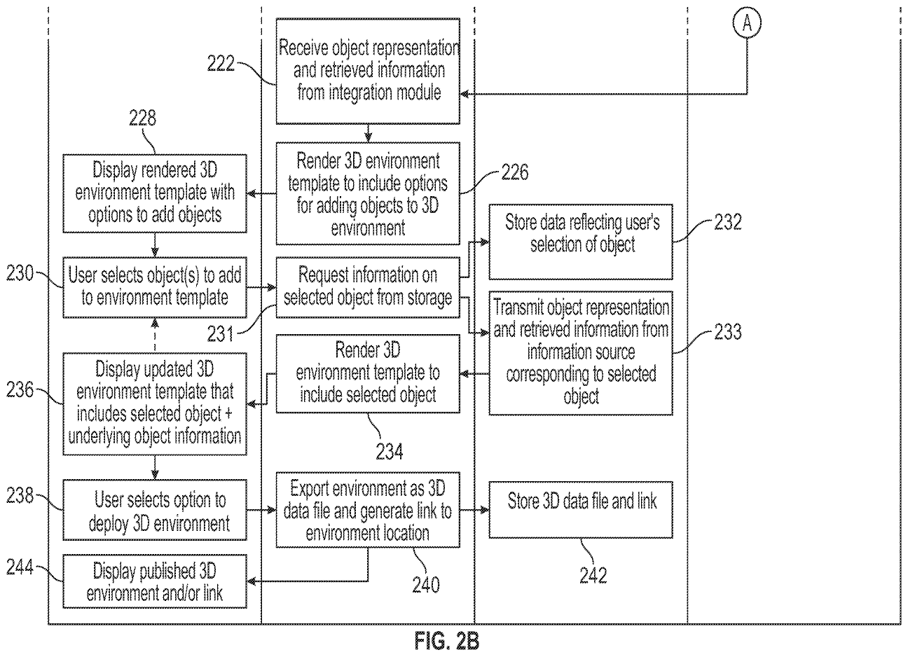

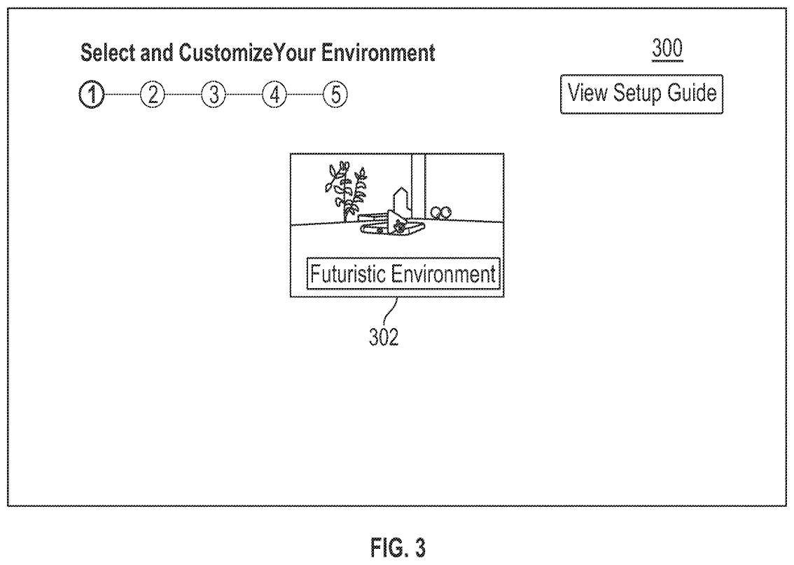

FIGS. 2A and 2B illustrate how the various components of system 100, such as client device 102 (displaying a user interface 202), 3D environment rendering platform 110, storage 104, and information source 108 may exchange information while executing a method of configuring and deploying a three-dimensional environment 200. As an initial step of method 200, (not shown in FIG. 2A), upon launching user interface 202, the user interface 202 may display options for different 3D environment templates to the user as previews in the user interface. An example of a displayed 3D environment template preview 302 in the user interface 202 is shown in FIG. 3 and will be described in further detail in the next section.

The 3D environment templates may be pre-designed by 3D environment rendering platform 110 of system 100 prior to the launch of the user interface 202, or in some examples, the 3D environment templates may be open-source templates and/or designed using a design tool external to system 100 (e.g., Maya, Blender, etc.). In some examples, the 3D environment templates may be configured in accordance with programming guidelines to ensure that the 3D environment rendering platform 110 is able to readily identify and change attributes in the data embodying the 3D environment template on-the-fly as user edits are received. For example, data embodying the attributes of the 3D environment templates may be stored in storage 104 with naming conventions that are specific and descriptive, such as “Wall-1,” “Wall-2,” “Shelf_right,” “Shelf_left,” “Floor,” and so on. Attributes that are changeable in the 3D environment template may be identified with tags (e.g., colour_changeable: true, texture: changeable: true, attribute_name=color-changeable, etc.). Standardized naming conventions may be used for areas in the 3D environment template where user-added objects may be stored, such as “product-drop-1”, “product-drop-2,” and so forth. Areas where a user may upload a logo or video for inclusion in the 3D environment template may be programmed with the same dimensions across templates. Accordingly, following certain programming conventions across the 3D environment templates may allow the 3D environment rendering platform 110 to more efficiently translate user inputs into changes in the data embodying the 3D environment template to allow for efficient real-time rendering.

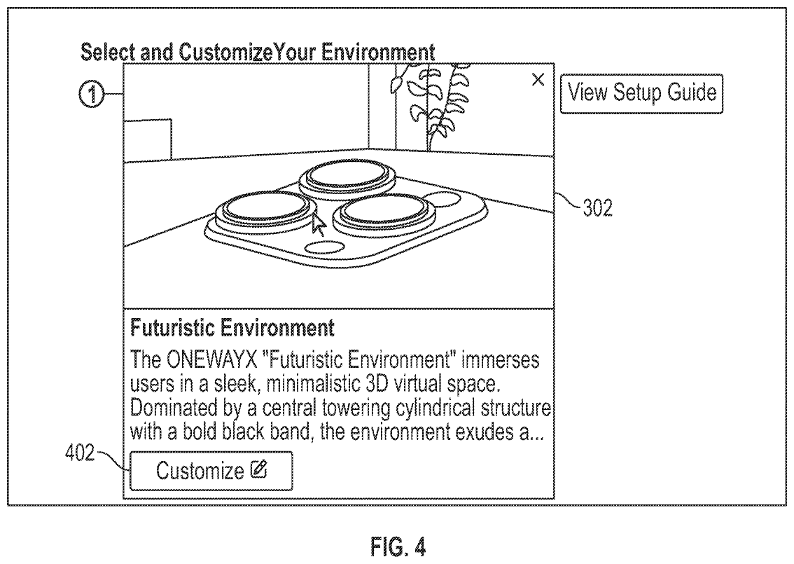

Still referring to method 200, at step 204, a user may select, via the user interface 202, a 3D environment template from among one or more of the 3D environment templates that were displayed as previews. An example of a user selection of a 3D environment template is shown in FIG. 4. For example, to select a 3D environment template, a user may select (e.g., click on or touch) the preview of the 3D environment template 302 and may then select a “customize” icon 402 to indicate their selection. At step 206 of method 200, 3D environment rendering platform 110 may receive an indication of the user's selection of the 3D environment template for customization, and at step 208, data associated with the user's selection (e.g., the name of the 3D environment template that they have selected) may be stored in storage 104. Additionally, at step 206, 3D environment rendering platform 110 may request data for rendering the selected 3D environment template (e.g., data representing the default configurations of the 3D environment template) from storage 104. At step 210, the data for rendering the selected 3D environment template may be retrieved from storage 104 and transmitted to 3D environment rendering platform 110.

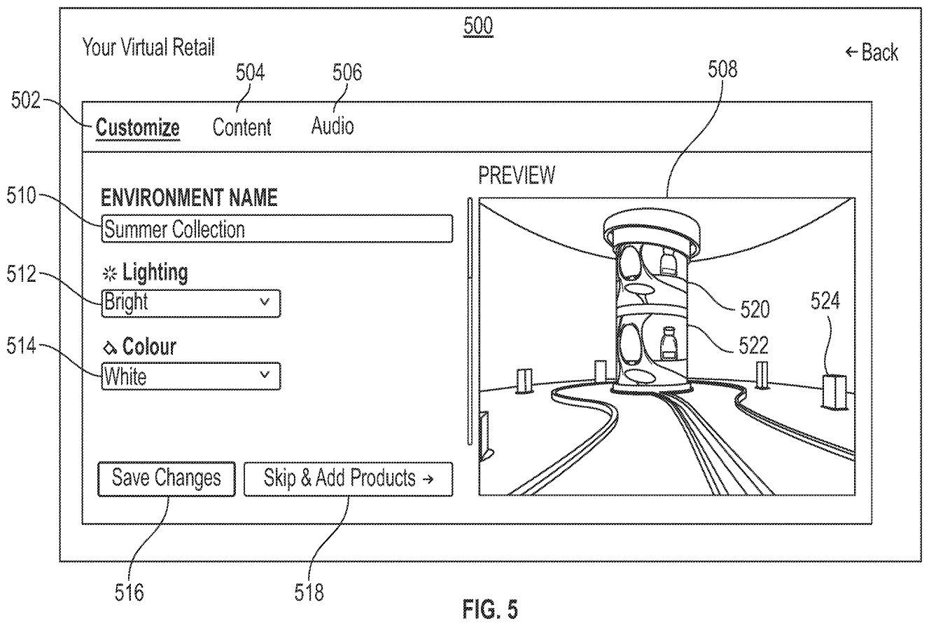

At step 212, the 3D environment rendering platform 110 may render the 3D environment template based on the default configurations. The 3D environment rendering platform 110 may transmit the rendered 3D environment template via the API to the user interface 202 and may store the 3D data file in storage 104. At step 214, the rendered 3D environment template may be displayed to the user in the user interface. An example of a rendered 3D environment template preview 508, as displayed in the user interface, is shown in FIG. 5. As shown by the dashed arrow from step 214 in FIG. 2A, in some examples, the actions performed in any of steps 204-214 may optionally be repeated as the user customizes the default configuration of the 3D environment template using the user interface 202. For example, at step 204, the user may select one or more options that are displayed in the user interface 202 for customizing the selected 3D environment template. At step 206, the 3D environment rendering platform 110 may receive the user's customizations, and in response, the 3D environment rendering platform 110 may transmit data representing the user's customizations to be stored in storage 104 at step 208.

Optionally, as shown by the dashed arrow from step 206 to step 212, the 3D environment rendering platform may not need to request data for rendering the user's customizations from storage 104. In other words, step 210 may only need to be performed once and may not need to be repeated as the user customizes the 3D environment template. The 3D environment rendering platform may instead access and update the default configurations of the 3D environment template in storage 104 directly each time a customization is made. At step 212, 3D environment rendering platform 110 may render the 3D environment template to reflect the user's customizations, and the rendered 3D environment template may be displayed to the user in the user interface 202, in real time, at step 214.

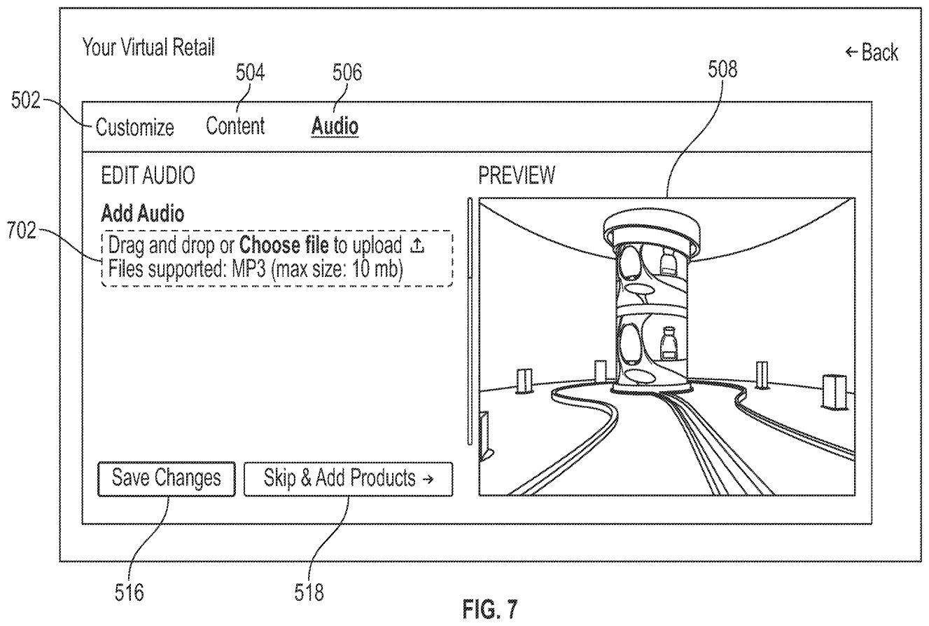

Once the user is satisfied with their customizations of the default configurations, a user may select an option for adding one or more 3D objects of their own to the 3D environment template. For example, as will be described with respect to FIG. 7, a user may select an icon 518 for adding one or more 3D objects to the 3D environment template (which, in the illustrated example, will be a 3D rendering of a product for sale). In response to making the user selection, a user may receive a prompt in the user interface for entering access parameters for an information source in order to add one or more objects to the 3D environment template, as will be described with respect to FIGS. 8 and 19.

Accordingly, still referring to FIG. 2A, at step 216 a user (e.g., a frontend user of user interface 202, or a backend system administrator) may input, into user interface 202, access parameters such as network location (e.g., a URL or API endpoint, an API key, etc.) for accessing an information source 108. Information source 108 may include information about one or more objects to be added to the 3D environment. A user may optionally input a representation of the object (e.g., a pre-generated 3D model of the object that the user has provided, or a 2D image that may be converted into a 3D rendering of the object by system 100) at step 216.

In some examples, integration module 106 may retrieve 2D or 3D representations of the objects directly from the information source 108 to automatically render the 3D environment template to include the objects. Further, system 100 may include one or more generative AI models, such as DALL-E, Midjourney, or StableDiffusion that may be configured to generate 3D models of objects based on uploaded 2D images or text or natural language descriptions of the objects included in information source 108. In this manner, that 3D renderings of objects can be generated even if no visual representation of the object is provided in the information source or by the user at step 216. The generative AI models may be configured to generate representations of objects that can be used by the 3D environment rendering platform 110 to render the objects in the 3D environment template.

At step 220, integration module 106 may access information source 108 using the access parameters that were inputted at step 216. Then, the integration module 106 may retrieve object information from the information source 108. As described above, this may involve accessing, by the integration module 106, the front-facing side of information source 108 (such as a front-facing web page or the frontend of another software application) as well as accessing the API of information source 108 to retrieve data from the backend of the information source 108. Using FIG. 8 as an example, the information source 108 accessed by the integration module 106 may be a merchant's website, and the objects to be displayed in the 3D environment template may be products or merchandise for sale. For example, integration module 106 may retrieve product information such as the products for sale and the options for different styles, colors, and sizes, and inventory information about the amount of stock for each of the products. In some examples, integration module 106 may retrieve visual representations of objects, such as 2D images or 3D models, from information source 108 instead of or in addition to the object representation optionally inputted at step 216.

At step 221, integration module 106 may also store the retrieved information, optionally along with the object representation received from the user at step 216, in storage 104. One advantage of directly accessing, via integration module 106, the API of the information source 108 is that changes made to the backend information of the information source 108 may be automatically reflected in storage 104. For example, the information in the information source may be retrieved by integration module 106 at regular time intervals and/or responsively to the detection of changes made to the information in the information source 108 in order to improve the end user experience. For example, as information in the information source 108 changes (e.g., as products go in and out of stock), the most current information may be displayed to an end user as they interact with different objects within the deployed 3D environment, as will be described.

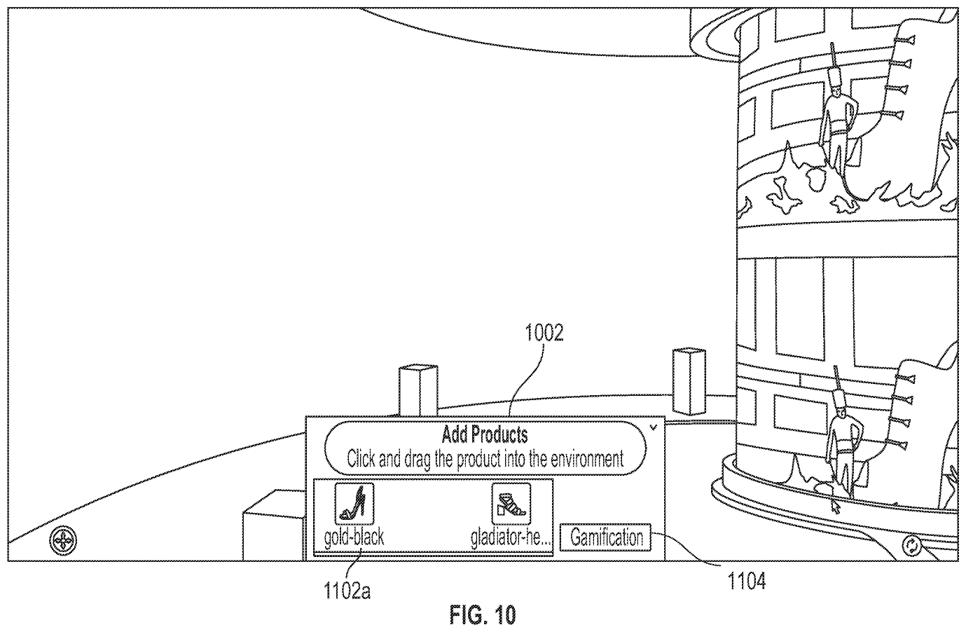

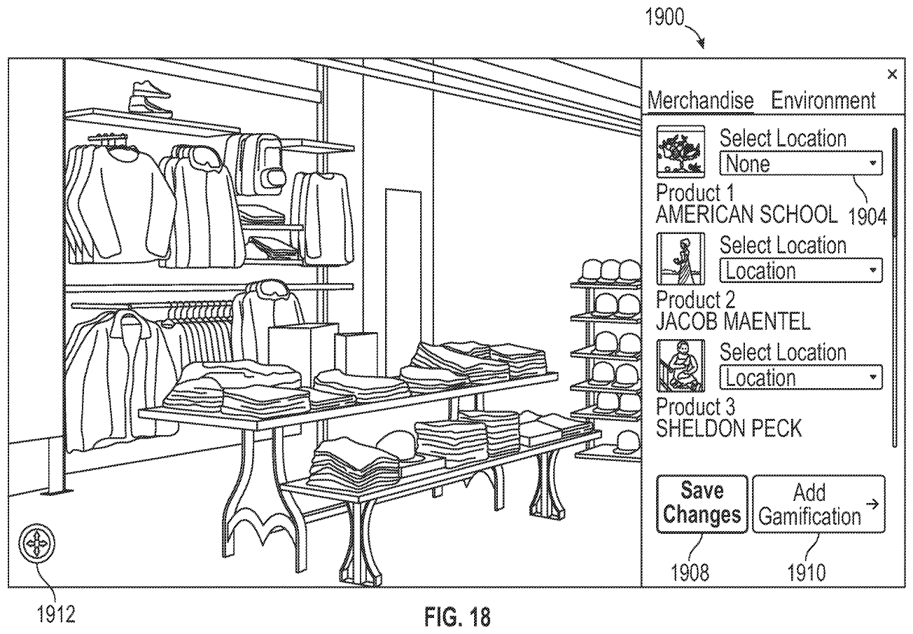

Continuing from FIG. 2A to FIG. 2B at point A, at step 222, 3D environment rendering platform 110 may receive an object representation and/or the information that was retrieved from the information source 108. At step 226, 3D environment rendering platform 110 may render the 3D environment template to include options for adding one or more objects from information source 108 into the 3D environment template. The updated rendered environment template including the options to add the objects may be displayed in the user interface 202 at step 228. Examples of rendered environments including options for adding one or more objects at step 228 are shown in FIGS. 10 and 18, where the 3D environment template includes an object selection menu 1002, 1900 from which the user may select one or more objects to be displayed. In FIG. 10, the objects are shoes to be displayed in a 3D storefront, and in FIG. 18, the objects are pieces of artwork. At step 230, a user may select, via the user interface, an object to add to the 3D environment template. As will be described, the user may make this selection by selecting an object in the object selection menu 1002, and then selecting a virtual location in the 3D environment template where they would like the object to be displayed. In some examples, the user may select an object and may drag and drop the object onto the desired virtual location in the 3D environment template. In some examples, as shown from the dropdown menus 1904 in FIG. 18, the user may select from one or more locations that are preconfigured for displaying the object in the 3D environment template.

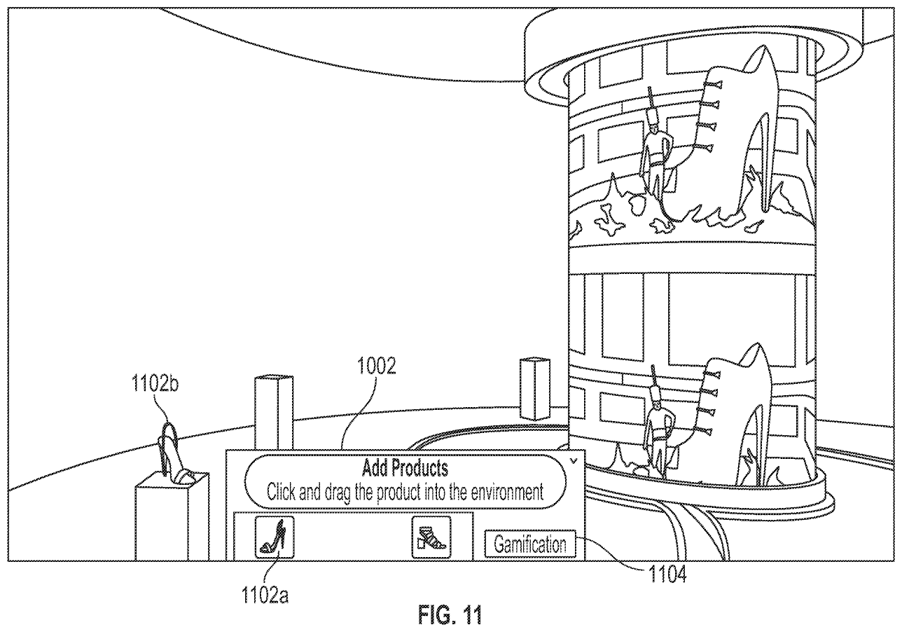

At step 231, the 3D environment rendering platform 110 may request information on the selected object that has been stored in storage 104. This information may include, for example, information that is to be displayed to an end user upon interacting with the selected object. At step 232, 3D environment rendering platform 110 may store data reflecting the user's selection of the object, along with the selected virtual location of the object (e.g., x, y, and/or z-coordinates within the 3D environment template, or the selected preconfigured location) in storage 104. At step 233, information on the selected object, along with an object representation that was stored in storage 104 after being inputted by the user or generated by the system, may be transmitted to the 3D rendering engine 110. Based on the information retrieved from storage 104, 3D environment rendering platform 110 may render the 3D environment template to include the selected object at the selected virtual location at step 234. The updated rendered 3D environment template including the selected object at the selected location may be displayed to the user in the user interface 202 at step 236. FIG. 11 illustrates an example of step 236, in which a selected object (shoe 1102b) has been added to the 3D environment template at a location selected by the user. As indicated by the dashed arrow from step 236 in FIG. 2B, steps 230-236 may optionally be repeated for each object that the user may choose to add to the 3D environment template, with the 3D environment rendering platform 110 rendering the 3D environment template on-the-fly while the user makes their selections.

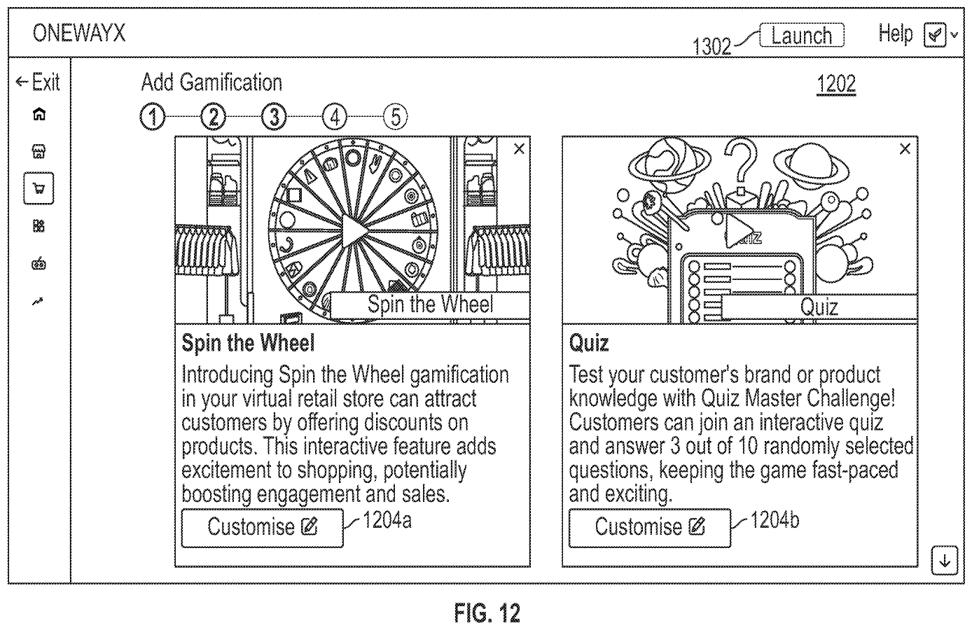

Once the user has finished customizing the 3D environment template, at step 238, a user may select an option that is displayed in the user interface 202 for deploying the 3D environment. For example, as shown in FIG. 12, a user may select a “launch” icon 1302. In response to the user selecting the option to deploy the 3D environment, at step 240, 3D environment rendering platform 110 may export the most current rendering of the 3D environment template as a 3D data file such as a GLB or GLTF file. At step 240, 3D environment rendering platform 110 may deploy the 3D environment at a network location and may generate location information for accessing the 3D environment (e.g., a URL or a link to a location within a virtual reality space). At step 242, the link, along with the 3D data file representing the published 3D environment, may be stored in storage 104. At step 244, the link may be displayed to the user in the user interface 202. From step 244, a user may copy and share the link with end users (e.g., customers) who may then view and interact with the published version of the 3D environment.

### Exemplary User Interface for Configuring and Deploying 3D Environments

FIGS. 3-16 and 18-21 illustrate an example of user interface 202, which may allow a user to customize templates of 3D environments to create their own immersive experiences for other users. Typically, designing immersive 3D environments requires a high degree of design and technical expertise, and a user may not be able to view the rendered results of their design choices in real-or near-real time. However, user interface 202 allows the user to enter inputs for creating their own custom 3D environments in an easy-to-understand workflow, and further allows the user to visualize results as updated 3D renderings of the virtual environment that are displayed in real-or near-real time. In user interface 202, the user may progress through a design flow that includes 1) selection of the 3D environment template; 2) customization of pre-configured 3D environment template design; 3) customization of the 3D environment template with user-selected objects; 4) addition of gamification elements; and 5) deployment of the 3D environment from the 3D environment template.

FIG. 3 illustrates a preview page 300 of different 3D environment templates that may be displayed to the user for their selection. Although only one preview of a 3D environment template 302 is shown in FIG. 3, a plurality of previews may be displayed to the user based on the 3D environment templates that are stored in storage 104. In some examples, not all elements of the 3D environment templates are configurable by the user. There may be base features, such as the overall environment layout and the locations of certain base structures that may be fixed in certain configurations in the 3D environment template. Accordingly, the user's selection of the 3D environment template may dictate which options are displayed and available to the user in user interface 202 during customization.

A user may preview a 3D environment template, for example, by selecting (e.g., clicking or tapping on) the displayed preview. The user's selection may cause additional information on the selected 3D environment template preview 302, such as a text description of the environment, to be displayed to the user as shown in FIG. 4. The user may finalize their selection of the 3D environment template for editing by selecting the “customize” icon 402. Then, the user interface may change to display the 3D environment customization page 500 shown in FIG. 5, in which a 3D environment template preview 508 may be displayed to the user. Optionally, the 3D environment template preview 508 may provide an interactive preview that a user may navigate through using the user interface (for example, by selecting a navigation menu 1912 as shown in FIG. 18, or by using arrow keys or “WASD” controls on their keyboard). The 3D environment template preview 508 may include certain structural features such as media displays 520, 522 and object pedestals 524 that may be at a fixed location within the 3D environment template.

The user interface may include different menus for configuring different attributes of the 3D environment template. For example, as shown in FIG. 5, a “customize” menu 502, a “content” menu 504, and an “audio” menu 506 may provide different options for configuring different attributes of the 3D environment template. However, more or less customization options and menus may be present in some examples. A user may toggle between displaying different customization options by selecting the different menus 502, 504, 506 and may select the “save” icon 516 to save their progress. A user may not need to enter customizations at each customization stage, optionally leaving certain preconfigured attributes of the 3D environment template unchanged.

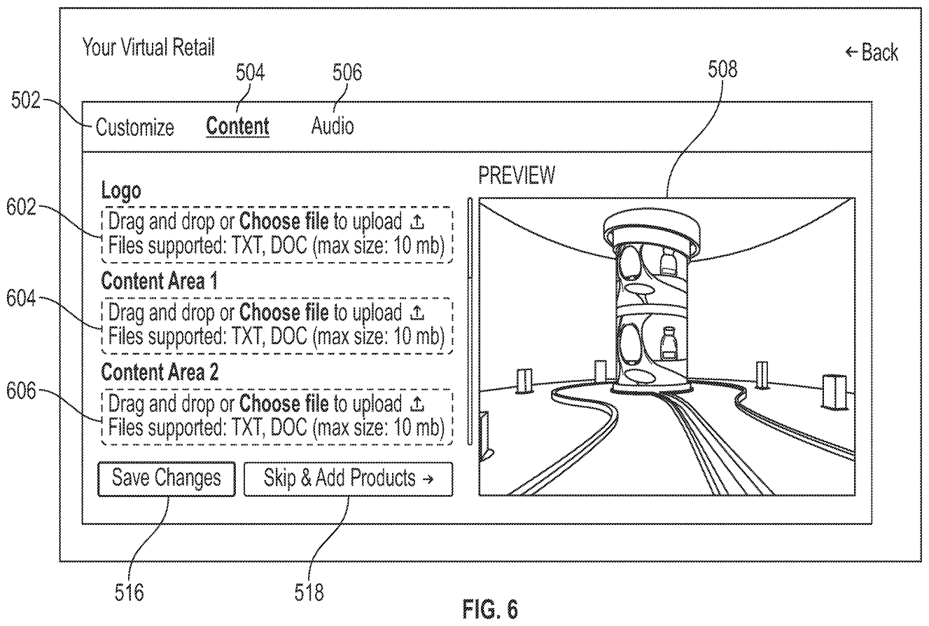

As shown in FIG. 5, customize menu 502 may include a field 510 for entering a name for the 3D environment template, a dropdown menu 512 for selecting between different lighting options, and a dropdown menu 514 for selecting between different accent colors. Turning to FIG. 6, the user may select the “content” menu 504, which may cause the display of a logo upload field 602, a first content upload field 604, and a second content upload field 606. Uploading a file in logo upload field 602 may cause the contents of the file (e.g., a brand logo or slogan) to be displayed at a preconfigured location within the 3D environment template (for example, on the walls, flooring, the top or bottom of the screen, or on designated signage). Uploading a file in first content upload field 604 and/or second content upload field 606 may cause the contents of the file to be displayed on media displays 520 and/or 522 in the 3D environment template. File types that may be uploaded by the user in fields 602, 604, 606 may include image file types (e.g., JPEG, PNG, GIF, TIFF), video file types (e.g., MP4, MOV, AVI, FLV), and/or document file types (e.g., TXT, DOC, PDF, HTML). As shown in FIG. 7, the user may select the “audio” menu 506 to cause the display of audio upload field 702. This may allow a user to add background music or sound effects to the 3D environment template. Audio file types that may be uploaded in audio upload field 702 may include MP3, WAV, AAC, and any other suitable file type.

As the users make their configurations, the 3D environment template 508 may be rendered by the 3D environment rendering platform 110 and displayed in real time. Accordingly, the user may view their customizations as they are made. Once the user has made their customizations, the user may select the “save changes” icon 516, which may cause data reflecting the user's selections to be stored in storage 104. Once the user is satisfied with their customizations, the user may select an “add object” icon 518 to begin populating the 3D environment template with objects of their choosing. In the illustrated example, the objects to be added to the 3D environment template by the user are products to be displayed for sale. However, the functionalities to be described with respect to adding user-uploaded objects to the 3D environment template may apply to any type of object from an information source 108 that the user wishes to add to their environment.

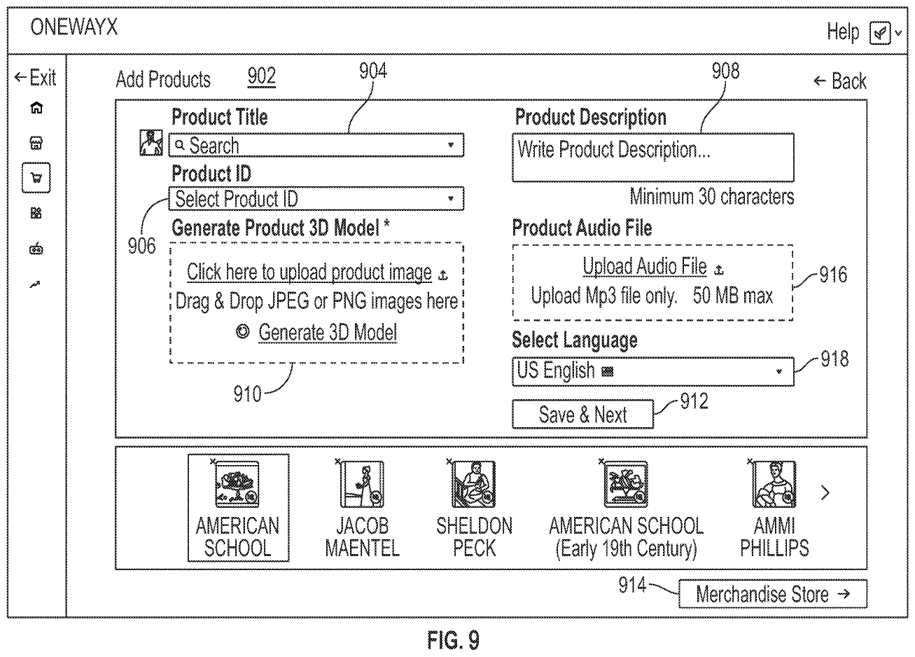

Once the user selects the “add object” icon 518, shown in FIGS. 5-7, this may cause information source input page 802 to be displayed in the user interface, transitioning the user to the next step of the design flow. In the information source input page 802, there may be a field 804 for the user to input one or more access parameters (e.g., a URL) for an information source 108 that contains information on one or more objects that the user would like to add to the user interface. In this example, the information source 108 is a merchant's website, and the access parameter is a URL to the website. The user may optionally upload one or more 3D object models, or these may be generated by the 3D environment rendering platform 110 as will be described with respect to FIG. 9. The user may then select icon 806 for importing object information, which may cause the integration module 106 to retrieve information from information source 108 (illustrated here as the merchant's website), as described with respect to steps 216-222 of method 200.

In some examples, a backend user of 3D environment rendering platform 110 may configure a frontend user profile to be associated with access parameters or credentials for accessing an information source, such that the user may not be required to enter access credential into an information source input page 802. An example of a profile configuration page 2000 is shown in FIG. 19. As shown, a backend user may enter access parameters into a URL field 2002, an access token field 2004, an API password field 2006, an admin token field 2008, and/or an API key 2010. The fields for entering different access parameters may vary between different types of users or information sources. Examples of access parameters that may be associated with a user profile include an API Key, an API Password, an access token, an admin token, a consumer key, a consumer secret, an API login endpoint, a product inventory API endpoint, admin API credentials, and so on. If a frontend user profile has been configured to include access parameters associated with an information source, the user's selection of the “add object” icon 518 may cause the integration module 106 to be automatically provided with the access parameters for accessing the information source 108. The integration module 106 may retrieve information from the information source, and the user may then be automatically directed to the object information page 902 shown in FIG. 9.

One benefit of using integration module 106 to directly access the API of information source 108 is that the retrieved object information may be automatically populated into the object information page 902 without the user having to manually input object information. Instead, retrieved object information may automatically populate in an object title menu 904, object ID field 906, and/or an object description field 908 for the user to select from and/or edit. For example, a user may select an object from object title menu 904, which may have been auto-populated with a list of the objects (e.g., products) on which information was stored in information source 108. Upon selecting an object from object title menu 904, object ID field 906 and/or object description field 908 may auto-populate with an ID and a description of the object that has been retrieved from information source 108. Optionally, the user may edit the auto-populated object description within object description field 908.

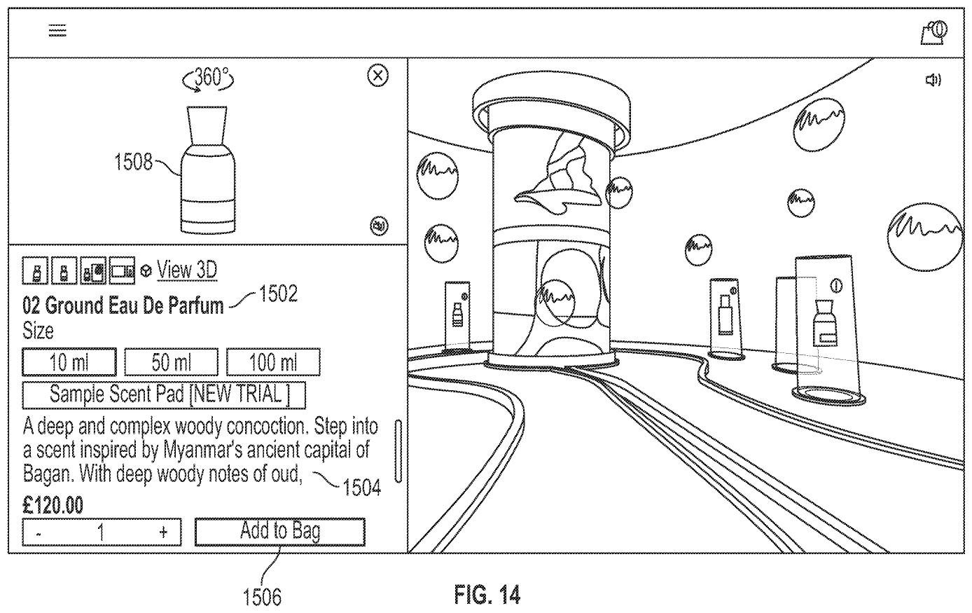

The user may additionally upload a visual representation of the object (e.g., a 2D image or a 3D model of the object) in the object upload field 910. The visual representation of the object uploaded by the user may be used by 3D environment rendering platform 110 to render the 3D object within the 3D environment template, for example, at steps 226 and/or 232 of method 200. Further, integration module 106 may be configured to retrieve object images or models from information source 108 for rendering the object, such that a user may not need to provide a visual representation of the object. As will be described with respect to FIG. 14, the user interface 202 may be configured such that, in response to an end user (e.g., a user other than the designer of the 3D environment, such as a customer) interacting with the rendered object, the retrieved information populated in object information page 902 may be displayed to the end user. A user may also upload an audio file in audio field 916 to be played to an end user in response to interaction with the object. A user may configure the language of text displayed to an end user of the 3D environment using language dropdown menu 918.

The user may optionally save the object information and select another object to be added to the 3D environment template using the “save and next” icon 912. This may cause the object information to be saved to storage 104. Then, the user may select a subsequent object from object title menu 904 to be added to the 3D environment template in the same manner. Once the user has finished making their edits, they may select icon 914 for adding the objects to the 3D environment template. As shown in FIGS. 10 and 18, selecting icon 914 may cause the 3D environment template to be displayed, along with an object selection menu 1002, 1900 (which may have been rendered by 3D environment rendering platform 110 as described with respect to step 226 of method 200).

Turning to FIGS. 11 and 18, the user interface may provide the user with different options for adding objects to the 3D environment template. As shown in FIG. 11, a user may add an object to the 3D environment template by selecting an object (e.g., object 1102a) from the object selection menu 1002. The user may drag and drop the object from the object selection menu 1002 onto the desired virtual location in the 3D environment template. The user may also be able make a first selection of the object representation at its virtual location within object selection menu 1002 (e.g., by clicking once on the object) and a second selection at a virtual location where the object is desired to be placed in the 3D environment template. As shown in FIG. 18, the user may be provided with a location dropdown menu 1904 associated with each selected object 1902. In the location dropdown menu 1904, the user may select from object display areas that have been pre-configured to display objects as part of the default configuration of the 3D environment template.

As the user selects objects to be added to the 3D environment template, the user's selections may be stored in storage 104, and 3D environment rendering platform 110 may render the 3D environment template in real time to include the selected object (e.g., selected object 1102b in FIG. 11) at the selected location. This process may be repeated (e.g., as described with respect to steps 230-236 of method 200) until the user has added each of the objects that they wish to showcase to end users of their 3D environment.

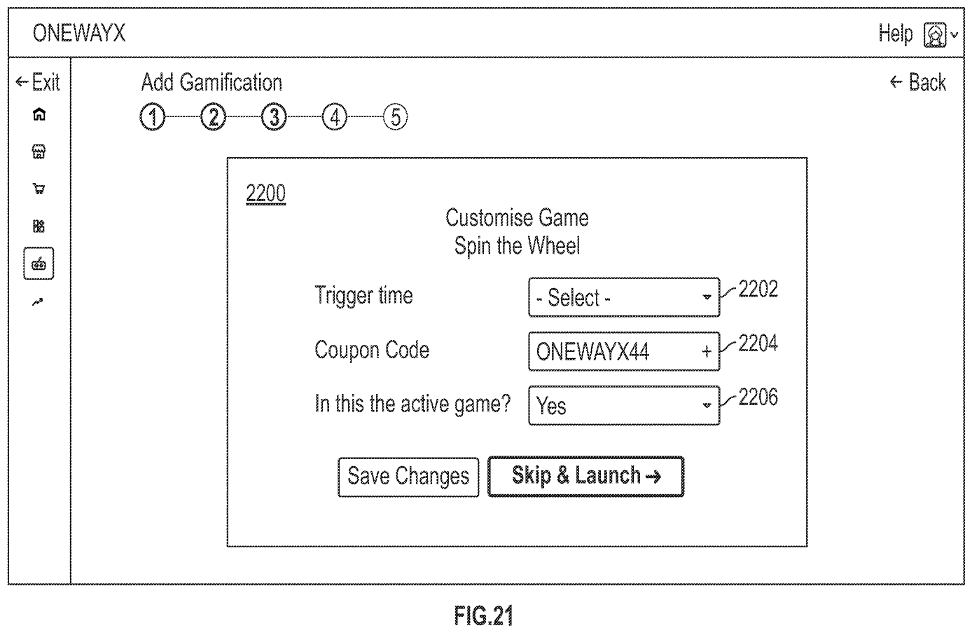

Optionally, a user may select a gamification icon 1104 to navigate to the next step of the design flow by virtue of the gamification page 1202 shown in FIG. 12. Although gamification icon 1104 is shown in object selection menu 1002 in FIGS. 10 and 11, in some examples, gamification icon 1104 may be located elsewhere in the user interface (e.g., as part of “customize” menu 502 shown in FIG. 5). From the gamification page 1202, a user may select one or more gamification elements to add to their 3D environment template. The gamification elements may include, for example, a spinning wheel, a quiz game, or any other interactive elements configured to engage with an end user of the 3D environment. A user may, for example, configure a spinning wheel game by selecting icon 1204a, which may navigate the user to the game editing page 2200 shown in FIG. 21. The user may select from one or more dropdown menus for editing different characteristics of the gamification elements. As shown in FIG. 21, for example, a user may make a selection from trigger time menu 2202 for configuring the trigger time (e.g., the time period from an end user entering the 3D environment to the time at which the game will be displayed to the end user). A user may add a coupon code into coupon code field 2204 to reward an end user for winning or participating in the game. A user may choose whether the game is to be set as active or inactive using dropdown menu 2206. Turning back to FIG. 12, a user may also configure a quiz game in a similar manner by selecting icon 1204b and adding one or more question and answer fields to populate the quiz.

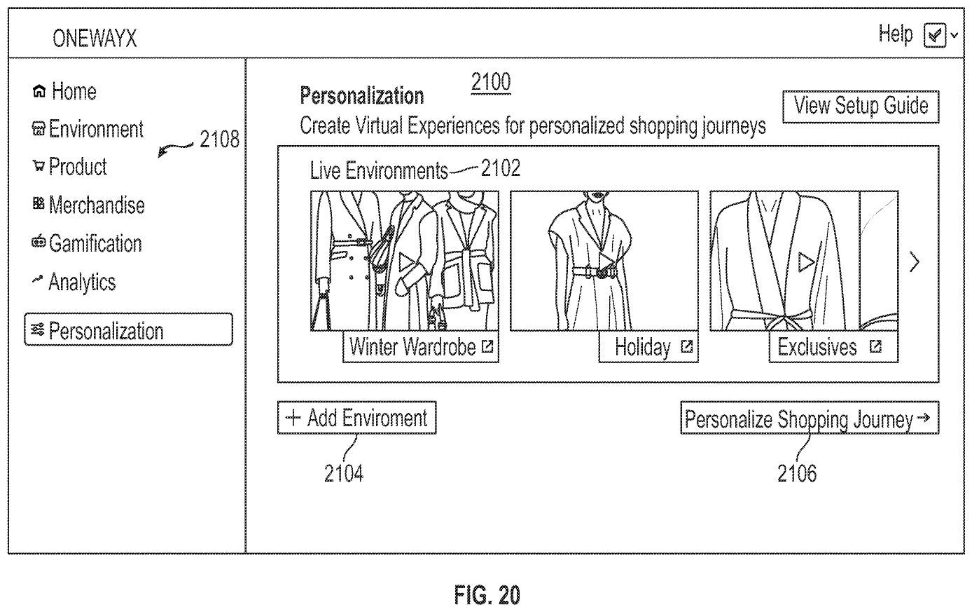

Once the user is satisfied with the customizations, objects, and interactive elements configured in the 3D environment template, the user may select an option for deploying the 3D environment template, such as the “launch” icon 1302 as shown in FIG. 12. Although “launch” icon 1302 is shown as part of gamification page 1202, it may be displayed in any suitable location in the user interface. Selecting the “launch” icon may cause the 3D environment rendering platform 110 to render and export the finalized 3D environment as a GLB or GLTF file, where it may be stored in storage 104. In some examples, a user may make changes to the published 3D environment by going through the steps of the design flow (e.g., environment customization, inputting object information and placing objects into the 3D environment template) by selecting the “environment” option in navigation menu 2108, shown by way of example in FIG. 20. Navigation menu 2108 may be displayed throughout the customization process, or it may be collapsed or hidden by the user of the user interface. Accordingly, although navigation menu 2108 is shown in FIG. 20, the navigation menu 2108 may be displayed in a similar manner in any of FIGS. 3-16 or 18-21.

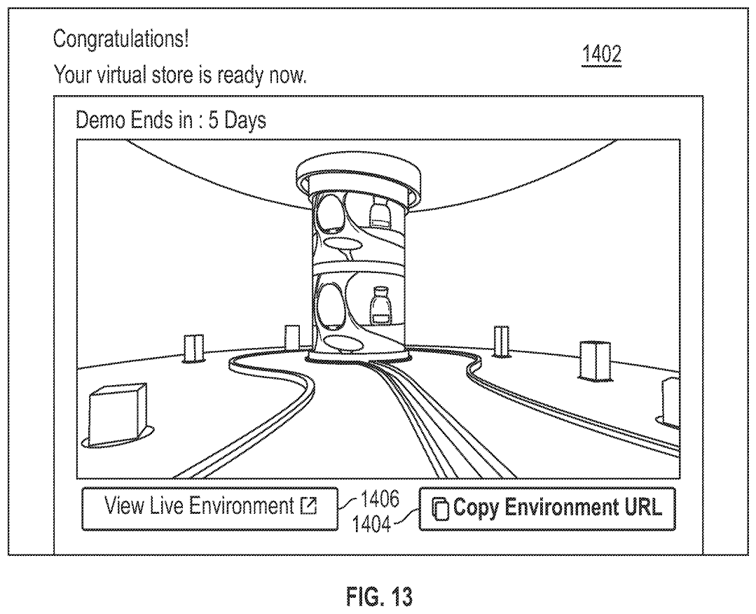

Once the final rendering process is complete, the rendered 3D environment may be deployed at a network location, and deployment page 1402 may be displayed in the user interface, as shown in FIG. 13. On deployment page 1402, a user may select an icon 1406 for viewing the deployed 3D environment and/or an icon 1404 for copying a unique, shareable URL to the network location of the deployed 3D environment. The user may copy and share the link with end users (e.g., via social media, targeted ad campaigns, etc.). The user may optionally choose to edit the accessibility of their 3D environment, making the environment accessible to all end users or only certain end users, regardless of whether or not they have been shared the URL.

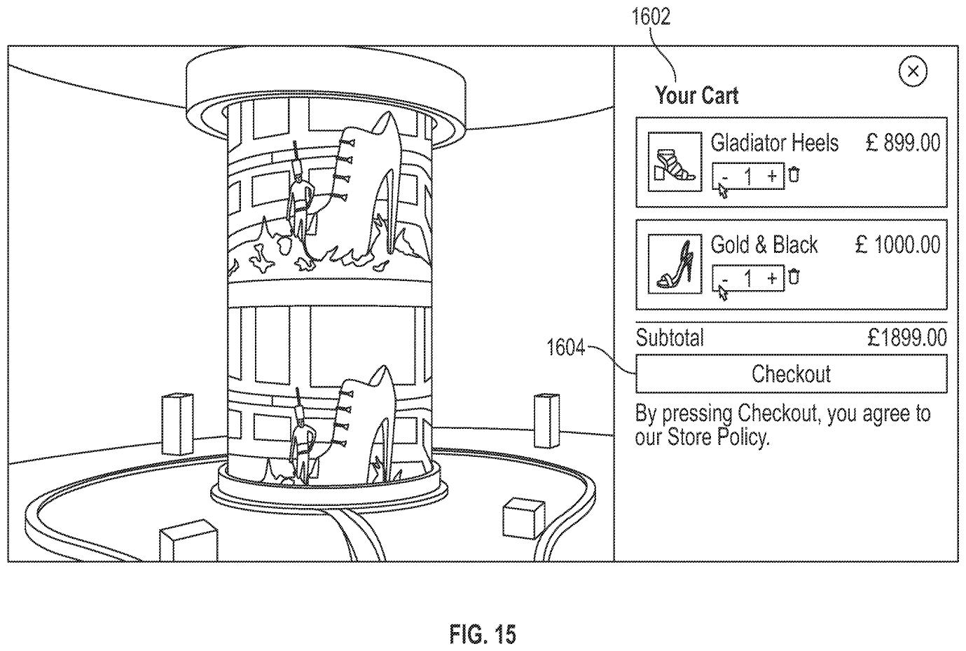

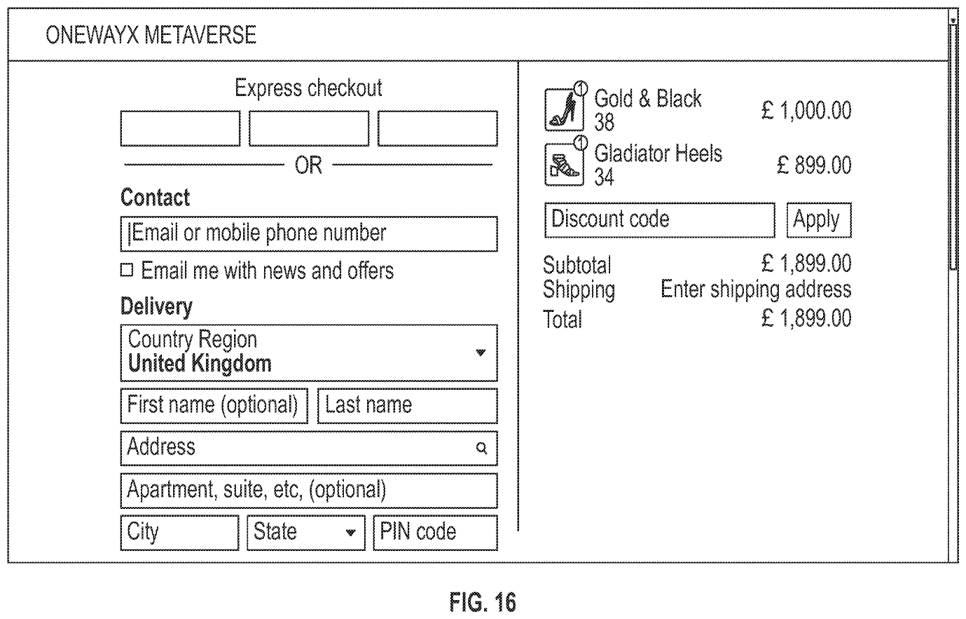

The deployed 3D environment may be configured to provide an interactive 3D experience to an end user. FIGS. 14-16 illustrate exemplary end user experiences with deployed 3D environments. For example, an end user may be able to navigate through the 3D environment and interact with the different objects in the 3D environment using their keyboard, mouse, touch screen, and so on. The 3D environment may be configured such that, in response to detecting end user interaction with an object in the 3D environment, information from information source 108 associated with the object (e.g., a product description, available sizes, and/or price information) is presented to the end user. For example, as shown in FIG. 14, selecting an object in the 3D environment may cause the display of the object ID 1502, the visual representation of the object 1508 (which, in this example, is an interactive 3D model of a perfume bottle), and/or the object description 1504. Selecting an object in the 3D environment may also cause audio 1510 associated with the object to play for the end user. The 3D environment may include interactive merchandising elements, such as a virtual cart 1602 and payment icon 1604 of FIG. 15. Upon an end user selecting payment icon 1604, the end user may be automatically directed to a merchant's external payment platform 1702 as shown in FIG. 16 in order to complete their purchase.

Optionally, as shown in FIG. 20, a user may create personalized end user experiences using a personalization page 2100 accessible in navigation menu 2108. The personalized end user experiences may include multiple 3D environments that may be made available to an end user in a curated sequence or all at once. On the personalization page 2100, the user may select one or more of their deployed environments from an environment menu 2102 and/or may add a new environment using the add environment icon 2104. Upon selecting the icon for deploying the personalized end user experience 2106, the personalized end user experience may be deployed to a unique network location, and a shareable URL to the personalized end user experience may be provided.

Interactive end user experiences may be provided for applications outside of ecommerce using the systems and methods described herein. For example, a person of ordinary skill will recognize that the systems and methods for configuring and deploying 3D environments provided herein may be used in a variety of applications such as video game design, education, real estate, and virtual tourism without departing from the scope of the present disclosure.

1. A method of configuring and deploying a three-dimensional (3D) environment, comprising:
receiving, via a user interface, a selection of a 3D environment template for customization;
displaying the selected 3D environment template in the user interface;
receiving, via the user interface, one or more first inputs for configuring one or more attributes of the 3D environment template;
rendering the displayed 3D environment template to reflect the one or more first inputs;
receiving, via the user interface, one or more second inputs comprising one or more access parameters of an information source, the information source comprising information on one or more objects;
retrieving, based on the one or more second inputs, the information on the one or more objects from the information source;
receiving, via the user interface, one or more third inputs comprising a selection of one or more objects to be rendered in the 3D environment template;
rendering the 3D environment template to reflect the selection of the one or more objects in the one or more third inputs;
receiving, via the user interface, an instruction for deploying the 3D environment template; and
in response, deploying a 3D environment based on the 3D environment template and the retrieved information associated with the one or more objects,
wherein the 3D environment is accessible at a network location to one or more end users, and
wherein the 3D environment is configured as an interactive 3D environment that causes, in response to detecting end user interaction with the one or more objects in the 3D environment, display of the retrieved information associated with the one or more objects.

2. The method of claim 1, wherein the 3D environment template comprises an interactive preview of the 3D environment configured to be navigated using the user interface.

3. The method of claim 1, further comprising:
storing data representing one or more attributes of the 3D environment template in a cloud storage location; and
in response to receiving, via the user interface, the one or more first inputs for configuring the one or more attributes of the 3D environment template, updating the data representing the one or more attributes stored in the cloud storage location.

4. The method of claim 1, wherein the one or more first inputs for configuring the one or more attributes of the 3D environment template comprise an image to be displayed in the 3D environment template.

5. The method of claim 1, wherein the one or more first inputs for configuring the one or more attributes of the 3D environment template comprise video to be displayed in the 3D environment template.

6. The method of claim 1, wherein the one or more first inputs for configuring the one or more attributes of the 3D environment template comprise a selection of a gamification element to be displayed in the 3D environment template.

7. The method of claim 1, further comprising:
in response to receiving the instruction for deploying the 3D environment, generating a shareable link to the deployed 3D environment.

8. The method of claim 1, further comprising:
in response to receiving the instruction for deploying the 3D environment, exporting a file comprising the 3D environment template; and
storing the file comprising the 3D environment template.

9. The method of claim 1, wherein the one or more third inputs comprise a selection of one or more locations in the 3D environment template where the one or more objects are to be placed.

10. The method of claim 1, wherein the one or more access parameters comprise a URL, a URL endpoint, an API key, an API password, an access token, an admin token, a consumer key, a consumer secret, an API login endpoint, a product inventory API endpoint, admin API credentials, or any combination thereof.

11. A system comprising:
one or more processors; and
memory storing computer program code executable by the one or more processors to cause the system to:
receive, via a user interface, a selection of a 3D environment template for customization;
display the selected 3D environment template in the user interface;
receive, via the user interface, one or more first inputs for configuring one or more attributes of the 3D environment template;
render the displayed 3D environment template to reflect the one or more first inputs;
receive, via the user interface, one or more second inputs comprising one or more access parameters of an information source, the information source comprising information on one or more objects;
retrieve, based on the one or more second inputs, the information on the one or more objects from the information source;
receive, via the user interface, one or more third inputs comprising a selection of one or more objects to be rendered in the 3D environment template;
render the 3D environment template to reflect the selection of the one or more objects in the one or more third inputs;
receive, via the user interface, an instruction for deploying the 3D environment template; and
in response, deploy a 3D environment based on the 3D environment template and the retrieved information associated with the one or more objects,
wherein the 3D environment is accessible at a network location to one or more end users, and
wherein the 3D environment is configured as an interactive 3D environment that causes, in response to detecting end user interaction with the one or more objects in the 3D environment, display of the retrieved information associated with the one or more objects.

12. The system of claim 11, wherein the 3D environment template comprises an interactive preview of the 3D environment configured to be navigated using the user interface.

13. The system of claim 11, wherein the system is further caused to:
store data representing one or more attributes of the 3D environment template in a cloud storage location; and
in response to receiving, via the user interface, the one or more first inputs for configuring the one or more attributes of the 3D environment template, update the data representing the one or more attributes stored in the cloud storage location.

14. The system of claim 11, wherein the one or more first inputs for configuring the one or more attributes of the 3D environment template comprise an image to be displayed in the 3D environment template.

15. The system of claim 11, wherein the one or more first inputs for configuring the one or more attributes of the 3D environment template comprise video to be displayed in the 3D environment template.

16. The system of claim 11, wherein the one or more first inputs for configuring the one or more attributes of the 3D environment template comprise a selection of a gamification element to be displayed in the 3D environment template.

17. The system of claim 11, wherein the system is further caused to:
in response to receiving the instruction for deploying the 3D environment, generate a shareable link to the deployed 3D environment.

18. The system of claim 11, wherein the system is further caused to:
in response to receiving the instruction for deploying the 3D environment, export a file comprising the 3D environment template; and
store the file comprising the 3D environment template.

19. The system of claim 11, wherein the one or more third inputs comprise a selection of one or more locations in the 3D environment template where the one or more objects are to be placed.

20. The system of claim 11, wherein the one or more access parameters comprise a URL, a URL endpoint, an API key, an API password, an access token, an admin token, a consumer key, a consumer secret, an API login endpoint, a product inventory API endpoint, admin API credentials, or any combination thereof.

21. A non-transitory computer readable storage medium storing one or more programs, the one or more programs comprising instructions, which, when executed by a system comprising one or more processors and memory, cause the system to:
receive, via a user interface, a selection of a 3D environment template for customization; display the selected 3D environment template in the user interface;
receive, via the user interface, one or more first inputs for configuring one or more attributes of the 3D environment template;
render the displayed 3D environment template to reflect the one or more first inputs; receive, via the user interface, one or more second inputs comprising one or more access parameters of an information source, the information source comprising information on one or more objects;
retrieve, based on the one or more second inputs, the information on the one or more objects from the information source;
receive, via the user interface, one or more third inputs comprising a selection of one or more objects to be rendered in the 3D environment template;
render the 3D environment template to reflect the selection of the one or more objects in the one or more third inputs;
receive, via the user interface, an instruction for deploying the 3D environment template; and
in response, deploy a 3D environment based on the 3D environment template and the retrieved information associated with the one or more objects,
wherein the 3D environment is accessible at a network location to one or more end users, and
wherein the 3D environment is configured as an interactive 3D environment that causes, in response to detecting end user interaction with the one or more objects in the 3D environment, display of the retrieved information associated with the one or more objects.
